(19) United States
(12) Patent Application Publication
(10) Pub. No.: US 2024/0035533 A1
(43) Pub. Date: Feb. 1, 2024

(54) Multi-Axis Damper for Steering Rack Bar

(71) Applicant: Robert Bosch GmbH, Stuttgart (DE)

(72) Inventor: Max Mitchell, Florence, KS (US)

(21) Appl. No.: 17/876,783

(22) Filed: Jul. 29, 2022

(51) Int. Cl. F16F 1/38; B62D 3/12; F16F 1/373

(52) U.S. Cl. CPC F16F 1/3835; B62D 3/126; F16F 1/3732; F16F 2224/025

(57) ABSTRACT

A multi-strata radial damper configured to dampen forces exerted in a radial direction between a rack bar of an automobile and a bushing sleeve protecting the rack bar. The radial damper may include a stratum made of a polymer material. The radial damper may additionally dampen forces exerted in an axial direction between the tie rod and the bushing sleeve.

### TECHNICAL FIELD

This disclosure relates to dampener components implemented in automotive steering systems.

### BACKGROUND

Steering racks in automotive vehicles are subject to a number of forces while the vehicle is in motion. These forces can be experienced in axial directions and radial directions. Axial forces are encountered when the steering rack is subject to forces in a direction of the axis of the steering rack. Axial forces can negatively impact the performance of the vehicle by creating displacement of the steering rack, misalignment of the steering rack or the wheels, or creating wear and tear on the components of the steering rack. Radial forces are encountered when the wheels of the vehicle are subject to forces in a direction perpendicular to the axis of the steering rack. Radial forces can negatively impact the performance of the vehicle by creating misalignment of the steering rack of the wheels, or by creating wear and tear on the components of the steering rack. Because forces are exerted in a 3-dimensional space, external forces can comprise both axial and radial components.

What is desired is protection of the steering rack components from negative impacts of outside forces in both axial and radial directions. In existing systems, an axial damper may be applied to reduce the negative impacts of axial forces. However, it would be desirable to develop a damper that may be applied to conventional steering systems that additional provides damping protections against radial forces.

### SUMMARY

One aspect of this disclosure is directed to a radial damper configured to be positioned about a rack bar within a rack support bushing sleeve of an automotive steering rack in an automobile. The radial damper comprises a first stratum and a second stratum. The first stratum has a first inner surface disposed at a first radial proximity to the rack bar and at a first outer surface opposite the first inner surface. The second stratum has a second inner surfaced and a second outer surface, the second inner surface disposed at a second outward radial proximity to the rack bar greater than the first radial proximity and adjacent to the first outer surface. When in position during motion of an automobile, the radial damper dampens a radial force exerted upon the rack bar by the rack support bushing sleeve., The first stratum comprises a first thickness in a radial direction with respect to the rack bar and the second stratum comprises a second thickness in the radial direction with respect to the rack bar. The second stratum has a greater resilience to radial forces than the first material. In some embodiments, the radial damper further comprises a third stratum having a third inner surface and a third outer surface, the third inner surface disposed at a third outward radial proximity to the rack bar greater than the second radial proximity and adjacent to the second outer surface. The third stratum comprises a third thickness in the radial direction with respect to the rack bar, and the third outer surface is adjacent to a surface of the rack support bushing sleeve.

Another aspect of this disclosure is directed to a radial damper configured to be positioned about a rack bar within a bushing sleeve of an automotive steering rack in an automobile, the radial damper comprising a first stratum having a first rack surface, a first sleeve surface disposed parallel to the first rack surface, and a first interface surface, wherein the first rack surface is closer to the rack bar than the first sleeve surface, and the first sleeve surface is closer to the bushing sleeve than the first rack surface when the radial damper is positioned about the rack bar. The radial damper further comprises a second stratum having a second rack surface, a second sleeve surface disposed parallel to the second rack surface, and a second interface surface, wherein the second rack surface is closer to the rack bar than the second sleeve surface, and the second sleeve surface is to the bushing sleeve than the second rack surface when the radial damper is positioned about the rack bar. The radial damper further comprises a third stratum disposed between the first material and second material, the third material extending between the first interface surface and the second interface surface. The radial damper dampens a radial force exerted upon the rack bar by the bushing sleeve during motion of the automobile, wherein the first rack surface has a greater axial dimension than the first sleeve surface, and wherein the second sleeve surface has a greater axial dimension than the second rack surface.

A further aspect of this disclosure is directed to a radial damper configured to be positioned about a rack bar within a bushing sleeve of an automotive steering rack in an automobile. The radial damper comprises a first stratum having a first rack surface and a first interface surface. The first sleeve surface disposed parallel to the first axial surface. The first rack surface is closer to the rack bar than the first sleeve surface and the first sleeve surface is closer to the bushing sleeve than the first rack surface when the radial damper is positioned about the rack bar. The radial damper further comprises a second stratum disposed between the first stratum and the bushing sleeve. The radial damper dampens a radial force exerted upon the rack bar by the bushing sleeve during motion of the automobile. The second stratum extends from the first interface surface, wherein the first rack surface has greater axial dimension than the first sleeve surface, and wherein second stratum has a greater resilience to radial forces than the first stratum.

Another aspect of this disclosure comprises a radial damper configured to be positioned about a rack bar within a bushing sleeve of an automotive steering rack in an automobile. The radial damper comprises a first stratum having a first portion that abuts the rack bar and a second portion that abuts the bushing sleeve, and a second stratum that is disposed between the first portion and the bushing sleeve. The first portion and the second portion form an angle.

The above aspects of this disclosure and other aspects will be explained in greater detail below with reference to the attached drawings.

### BRIEF DESCRIPTION OF THE DRAWINGS

FIG. 1 is a cross-sectional view of a portion of a steering rack having a radial damper in place.

FIG. 2 is a view of a radial damper utilized in FIG. 1

FIG. 3 is a close-up cross-sectional view of the radial damper of FIG. 1 in position.

FIG. 4 is a cross-sectional view of a portion of a steering rack having a radial damper in place.

FIG. 5 is a close-up cross-sectional view of the radial damper of FIG. 4 in position.

FIG. 6 is a cross-sectional view of a portion of a steering rack having a radial damper in place.

FIG. 7 is a close-up cross-sectional view of the radial damper of FIG. 6 in position.

FIG. 8 is a view of an alternative embodiment of a radial damper.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

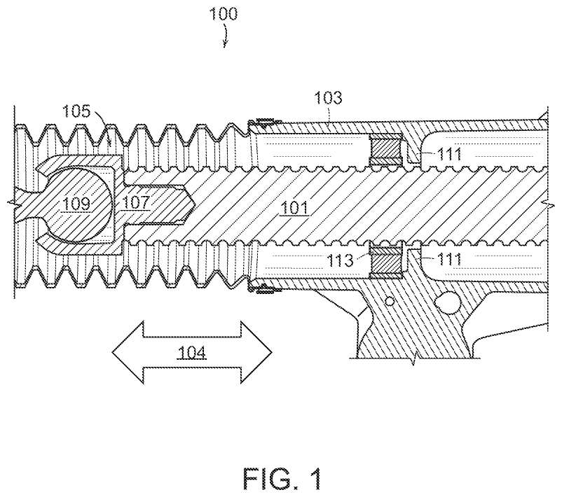

FIG. 1 shows a cross-sectional view of a steering rack 100 comprising a rack bar 101 and a bushing sleeve 103. Bushing sleeve 103 provides protection from the elements to rack bar 101 as well as provides direction and limitation to the motion of rack bar 101, providing reliable motion to steer the automobile comprising steering rack 100. A steering column (not shown) is operable to move steering rack 101 along an axial direction 104 of the steering rack 101. Rack bar 101 is affixed to a tie rod 105, coupling the wheels of the automobile to the rack bar 101 for purposes of controlled steering. In the depicted embodiment, tie rod 105 comprises a tie rod socket 107 coupled to rack bar 101 and a tie rod ball 109 coupled to a wheel (not shown). The tie rod ball 109 is coupled within the tie rod socket 107 to secure the wheel to the rack bar 101.

It is not desired for the rack bar 101 to be displaced too greatly along axial direction 104, as extreme displacements can force the wheels or the tie rod 105 to physically interact with other elements of the automobile in undesired ways. To prevent over-extension of rack bar 101 along axial direction 104, bushing sleeve 103 additionally comprises one or more retainers 111

Because rack bar 101 has a longitudinal shape, any forces applied to it in a direction perpendicular to axial direction 104 are necessarily radial forces. Application of radial forces to rack bar 101 may result in deformation or wear and tear on the components of steering rack 100 when the components interact with each other under force. For this reason, a radial damper 113 is positioned within the steering rack. Radial damper 113 is configured to dampen radial forces being applied to rack bar 101 and help minimize physical interaction between bushing sleeve 103 and other components of steering rack 100. In this disclosure, radial damper 113 also provides axial dampening to prevent direct interaction between tie rod 105 and any part of bushing sleeve 103, including retainers 111.

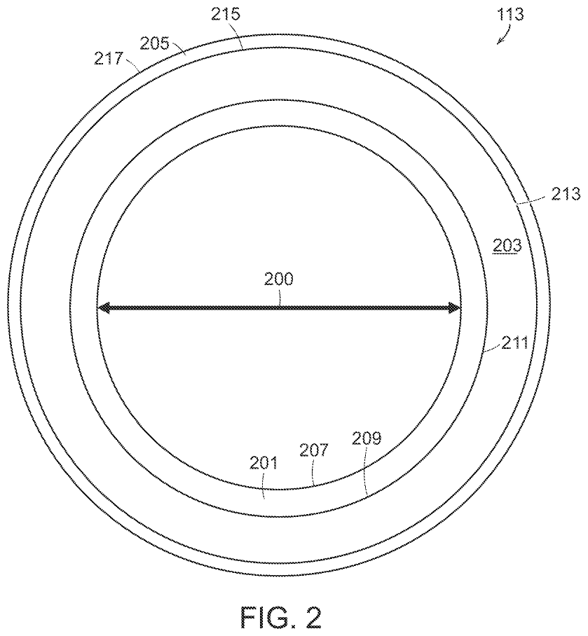

The arrangement of radial damper 113 is critical for optimization of the dampening effects. FIG. 2 provides an illustration of radial damper 113 to demonstrate the configuration of one embodiment of radial damper 113. Radial damper 113 comprises an annular shape, having an inner diameter 200. Inner diameter 200 may be an arbitrary size, though it must be large enough accommodate the diameter of rack bar 101 (see FIG. 1) without interfering with the operation of steering rack 100. In the depicted embodiment, radial damper 113 comprises a multi-strata configuration, including a first stratum 201, a second stratum 203, and a third stratum 205.

The first stratum 201 comprises a first material, and features a first inner surface 207 and a first outer surface 209 defining the bounds of first stratum 201. Notably, first inner surface 207 is configured to make contact with rack bar 101 (see FIG. 1) when rack bar 101 is subjected to radial forces. Because of this interaction, first stratum 201 is advantageously comprised of a material that is not hard enough to create damage to rack bar 101 via abrasion. In the depicted embodiment, the first material comprises a metal that is softer than the metal comprising rack bar 101. Other embodiments may comprise other material compositions without deviating from the teachings disclosed herein.

Second stratum 203 comprises a second material, and features a second inner surface 211 and a second outer surface 213 defining the bounds of second stratum 203. Second inner surface 207 is configured to make contact with the first outer surface 209 of first stratum 201. In the depicted embodiment, this contact between second inner surface 207 and first outer surface 209 is rendered a continuous static contact by coupling of the two strata using mechanical or chemical bonding techniques. Other embodiments may comprise other forms of contact between the two strata without deviating from the teachings disclosed herein. This coupling advantageously optimizes transfer of radial forces experienced by the contact between first stratum 201 and rack bar 101 into second stratum 203. Other embodiments may comprise other forms of contact between the two strata without deviating from the teachings disclosed herein. In the depicted embodiment, second stratum 203 is comprised of a second material that is distinct from the first material of first stratum 201. In the depiction of FIG. 2, second material comprises a polymer, such as an elastomer. The polymer material may be selected based upon desired properties, such as elasticity, hardness, and resilience. The elasticity in particular is advantageous because it provides a dampening effect on the radial forces transferred from rack bar 101 into radial damper 113, lessening the forces exchanged between the components and diminishing the wear and tear experienced during such interactions.

Third stratum 205 comprises a third material, and features a third inner surface 215 and a third outer surface 217 defining the bounds of third stratum 205. Third stratum 205 is configured to make contact with the second outer surface 213 of second stratum 203. In the depicted embodiment, this contact between third inner surface 215 and second outer surface 213 is rendered a continuous static contact by coupling of the two strata using mechanical or chemical bonding techniques. Other embodiments may comprise other forms of contact between the two strata without deviating from the teachings disclosed herein. In the depicted embodiment, the coupling advantageously reduces wear and tear on the second outer surface 213 and the third inner surface 215, extending the lifespan of both strata. Third outer surface 217 is configured to make contact with bushing sleeve 103 (see FIG. 1) when rack bar 101 is subjected to sufficiently large radial forces. Because of this interaction, third stratum 205 is advantageously comprised of a material that is not hard enough to create damage to bushing sleeve 103 via abrasion. In the depicted embodiment, the third material comprises a metal that is softer than the metal comprising bushing sleeve 103. In the depicted embodiment, the first material of first stratum 201 and the third material of third stratum 205 may be identical. Other embodiments make comprise other arrangements without deviating from the teachings disclosed herein.

In the depicted embodiment, each of first stratum 201, second stratum 203, and third stratum 205 comprises a thickness of the material from which it is made. With respect to these teachings, “thickness” is defined as extension of the material in a radial direction with respect to the annular shape of radial damper 113. In the depicted embodiment, each stratum exhibits its own unique thickness. However, other configurations may comprise other arrangements without deviating from the teachings disclosed herein. In some such embodiments, two or more of the strata may exhibit the same thickness without deviating from the teachings disclosed herein. By way of example, and not limitation, in some embodiments first stratum 201 and third stratum 205 may exhibit the same thickness as each other. This may advantageously permit manufacture of the radial damper 113 using a joint resource material.

In the depicted embodiment, the thickness of the first stratum 201 and the third stratum 205 are distinct. In such an embodiment, this difference may advantageously optimize the lifespan of the components of radial damper 113 because the first inner surface 207 is expected to interact with rack bar 101 much more frequently than the third outer surface 217 is expected to interact with bushing sleeve 103. As such, the differences in thickness may optimize the longevity of radial damper 113 while additionally maximizing the thickness of second stratum 203, which advantageously maximizes the damping effects. In the depicted embodiment, the polymer material of second stratum 203 has a greater resilience than metal materials used in the first stratum 201 or third stratum 205, but other embodiments may comprise other material characteristics without deviating from the teachings disclosed herein.

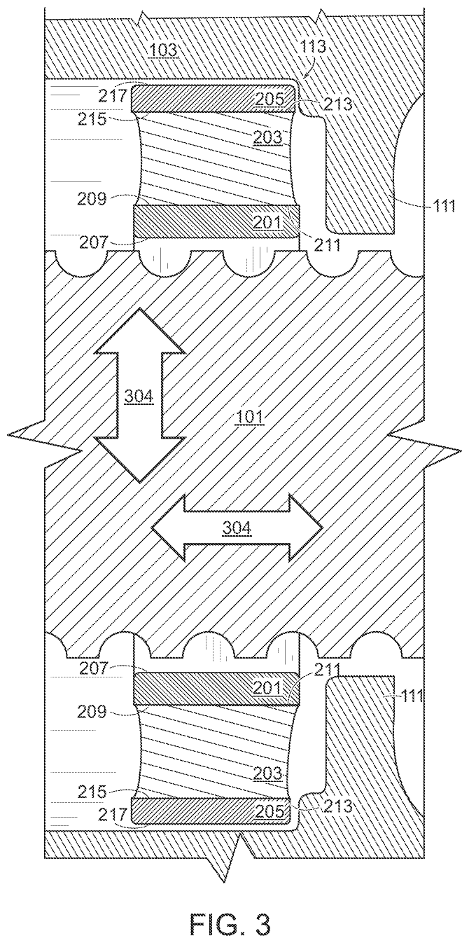

FIG. 3 provides a close-up cross-sectional view of radial damper 113 in position while situated about rack bar 101. Notably, whenever a radial force in a radial direction 304 is applied to rack bar 101 via the wheels (not shown), the rack bar 101 will first interact with radial damper 113 before it can interact with any portion of bushing sleeve 103. Although this cross-section is a two dimensional representation, any radial forces in any radial direction will yield interaction between rack bar 101 and radial damper 113 prior to any interaction with bushing sleeve 103. Notably, this includes portions of the bushing sleeve 103 that comprise the retainers 111.

In some embodiments, the axial alignment of one or more strata may exhibit a particular arrangement. For the purposes of this disclosure, a cross-sectional arrangement of strata may be considered to axially-aligned if the cross-sectional center point of each strata are aligned with respect axial direction 104 within a tolerance of 5% of the total axial dimension of each the respective strata. Two arranged strata may not exhibit the same size with respect to their respective axial dimensions. In such arrangements, the strata may be considered to be axially-aligned if the cross-sectional center points are aligned within a tolerance of 5% of the total axial dimension of the strata that exhibits a smaller size with respect to the axial dimension along axial direction 104. If the center points of any two strata are not aligned within the 5% tolerance, those strata are instead considered to be axially-offset.

In the depicted embodiment, radial damper 113 comprises a first stratum 201, second stratum 203, and third stratum 205 that are all axially-aligned. Other embodiments may comprise one or more strata which are axially-offset from other strata without deviating from the teachings disclosed herein. By way of example, and not limitation, one axially-offset embodiment may comprise a second stratum 203 disposed further from retainer 111 than first stratum 201. In such an embodiment, third stratum 205 may be disposed even further from retainer 111. Thus, in such an example embodiment, each of first stratum 201, second stratum 203, and third stratum 205 is axially-offset from the other strata. Other embodiments may comprise other arrangements of the strata with respect to axial alignment without deviating from the teachings disclosed herein.

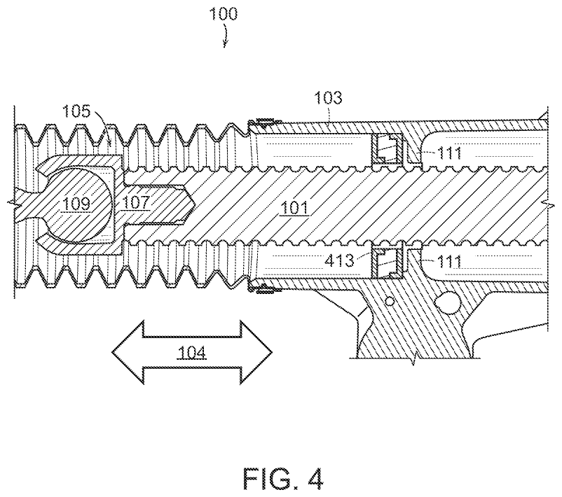

Other configurations of a radial damper may be utilized. FIG. 4 provides a cross-sectional illustration of the same steering rack 100 having an alternate radial damper configuration in the form of radial damper 413. Radial damper 413 retains the same general annular shape of radial damper 113 (see FIG. 2) but comprises a different arrangement of cross-sectional components.

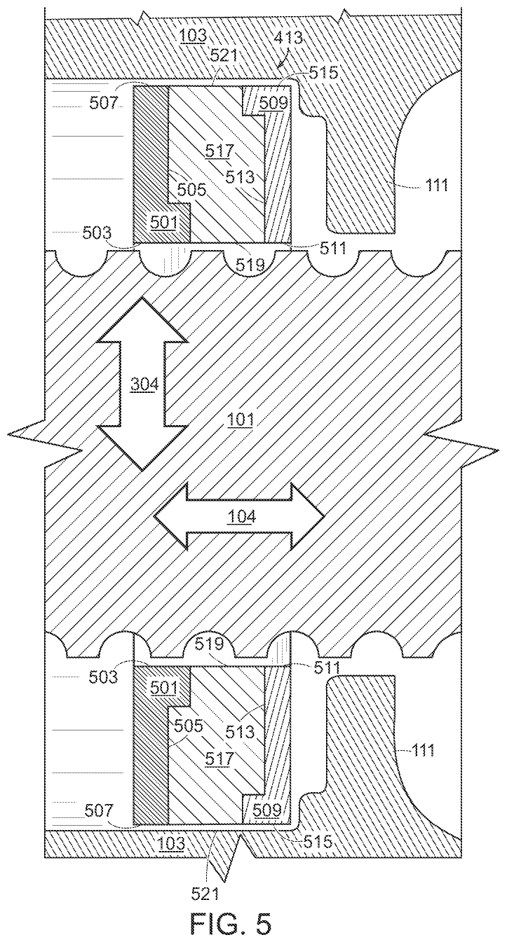

FIG. 5 provides a close-up cross-sectional view of radial damper 413 in position while situated about rack bar 101. Radial damper 413 comprises a first stratum 501 having a first rack surface 503, a first interface surface 505, and a first sleeve surface 507. In the first stratum 501, first rack surface 503 is disposed nearest to rack bar 101 and first sleeve surface 507 is disposed opposite first rack surface 503, itself being nearest to bushing sleeve 103. First interface surface 505 runs between first rack surface 501 and first sleeve surface 507. In the depicted embodiment, first rack surface 501 comprises a larger width than first sleeve surface 507, and first interface surface 505 comprises a bracket configuration, giving the cross section of first stratum 501 an ‘L’ shape. In the depicted embodiment, the ‘L’ shape comprises a right angle, but other embodiments may comprise other angles without deviating from the teachings disclosed herein. Other configurations may comprise other arrangements and dimensions without deviating from the teachings disclosed herein.

Radial damper 413 further comprises a second stratum 509 having a second stratum 509 having a second rack surface 511, a second interface surface 513, and a second sleeve surface 515. In the second stratum 509, second rack surface 511 is disposed nearest to rack bar 101 and second sleeve surface 515 is disposed opposite second rack surface 511, itself being nearest to bushing sleeve 103. Second interface surface 513 runs between second rack surface 511 and second sleeve surface 515. In the depicted embodiment, second rack surface 511 comprises a smaller width than second sleeve surface 515, and second interface surface 513 comprises a bracket configuration, giving the cross section of second stratum 515 an ‘L’ shape. In, the depicted embodiment, the ‘L’ shape comprises a right angle, but other embodiments may comprise other angles without deviating from the teachings disclosed herein. In the depicted embodiment, the orientation of the ‘L’ shape in the cross section is vertically inverted for second stratum 509 compared to first stratum 501. Other configurations may comprise other arrangements and dimensions without deviating from the teachings disclosed herein.

Radial damper 413 further comprises a third stratum 517 spanning between the first interface surface 505 and second interface surface 513. In the depicted embodiment, third stratum 517 comprises a third rack surface 519 disposed near to rack bar 101 and a third sleeve surface 521 disposed near to bushing sleeve 103. In the depicted embodiment, third stratum 517 spans between the first interface surface 505 and the second interface surface 513 for the entire length of each surface, but other embodiments may comprise other configurations without deviating from the teachings disclosed herein. In such embodiments, third rack surface 519 may be at a greater distance from steering rack 101 than either of first rack surface 503 or second rack surface 511 without deviating from the teachings disclosed herein. In such embodiments, third sleeve surface 521 may be at a greater distance from bushing sleeve 103 than either of first sleeve surface 507 or second sleeve surface 515 without deviating from the teachings disclosed herein.

First stratum 501 may comprise a metal. Second stratum 509 may comprise a metal, and in the depicted embodiment this metal may comprise the same metal as first stratum 501, though other embodiments may have other configurations without deviating from the teachings disclosed herein. Third Stratum 517 may comprise a polymer, and in particular an elastomer. In the depicted embodiment, none of the materials used in first stratum 501, second stratum 509, or third stratum 517 may be hard enough to damage either the rack bar 101 or the bushing sleeve 103 due to abrasion when contact is made because of radial forces exerted upon rack bar 101. Advantageously, third stratum 517 provides a dampening effect on the transfer of radial forces and axial forces experienced between rack bar 101 and bushing sleeve 103. The materials of each of first stratum 501, second stratum 509, and third stratum 517 should be chosen to withstand the forces expected without degrading or damaging radial damper 413 under normal operating conditions. In the depicted embodiment, the polymer material of third stratum 517 has a greater resilience than metal materials used in the first stratum 501 or second stratum 203, but other embodiments may comprise other material characteristics without deviating from the teachings disclosed herein.

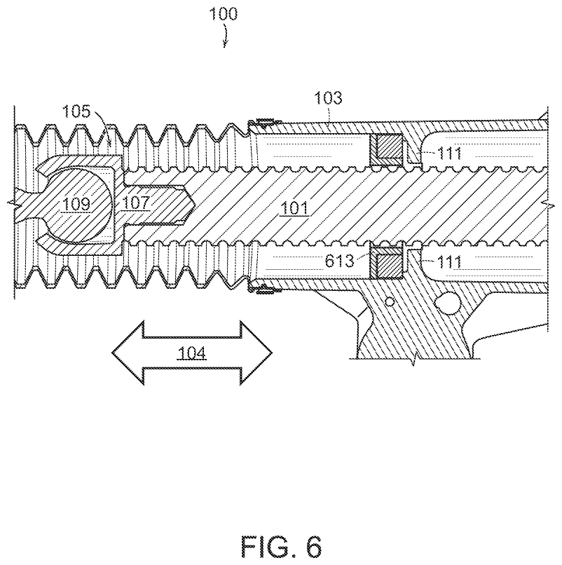

FIG. 6 provides a cross-sectional illustration of the same steering rack 100 having an alternate radial damper configuration in the form of radial damper 613. Radial damper 613 retains the same general annular shape of radial damper 113 (see FIG. 2) but comprises a different arrangement of cross-sectional components.

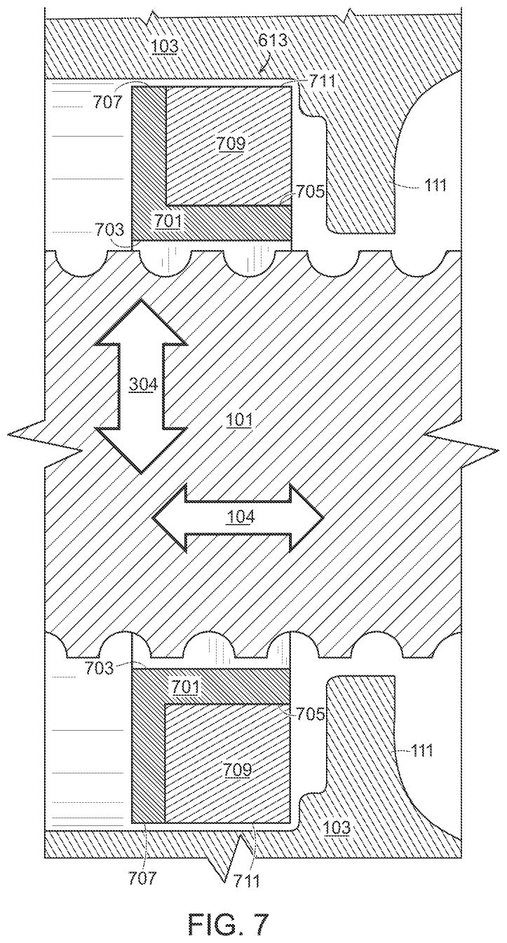

FIG. 7 provides a close-up cross-sectional view of radial damper 613 in position while situated about rack bar 101. Radial damper 613 comprises a first stratum 701 having a first rack surface 703, a first interface surface 705, and a first sleeve surface 707. In the first stratum 701, first rack surface 703 is disposed nearest to rack bar 101 and first sleeve surface 707 is disposed opposite first rack surface 703, itself being nearest to bushing sleeve 103. First interface surface 705 runs between first rack surface 701 and first sleeve surface 707. In the depicted embodiment, first rack surface 701 comprises a larger width than first sleeve surface 707, and first interface surface 705 comprises a bracket configuration, giving the cross section of first stratum 701 an ‘L’ shape. The ‘L’ shape of the cross section comprises a right angle in the depicted embodiment, but other embodiments may comprise other angles without deviating from the teachings disclosed herein. Other configurations may comprise other arrangements and dimensions without deviating from the teachings disclosed herein.

Radial damper 613 additionally comprises a second stratum 709 extending from first interface surface 705. In the depicted embodiment, second stratum 709 comprises a second sleeve surface 711 that is disposed nearer to bushing sleeve 103 than to the first interface surface 705. In the depicted embodiment, second stratum 709 is configured to engage with bushing sleeve 103 directly when rack bar 101 is subject to radial forces under normal operating conditions. Accordingly, second stratum 709 is comprised of a material that will not damage bushing sleeve 103 via abrasion or other interactions during motion of the automobile in normal operating conditions.

First stratum 701 may comprise a metal. Second stratum 709 may comprise a polymer, and in particular an elastomer. In the depicted embodiment, none of the materials used in first stratum 701 or second stratum 709 may be hard enough to damage either the rack bar 101 or the bushing sleeve 103 due to abrasion when contact is made because of radial forces exerted upon rack bar 101. Advantageously, second stratum 709 provides a dampening effect on the transfer of radial forces and axial forces experienced between rack bar 101 and bushing sleeve 103. The materials of each of first stratum 701 and second stratum 709 should be chosen to withstand the forces expected without degrading or damaging radial damper 413 under normal operating conditions. In the depicted embodiment, the polymer material of second stratum 709 has a greater resilience than the metal materials used in the first stratum 201, but other embodiments may comprise other material characteristics without deviating from the teachings disclosed herein.

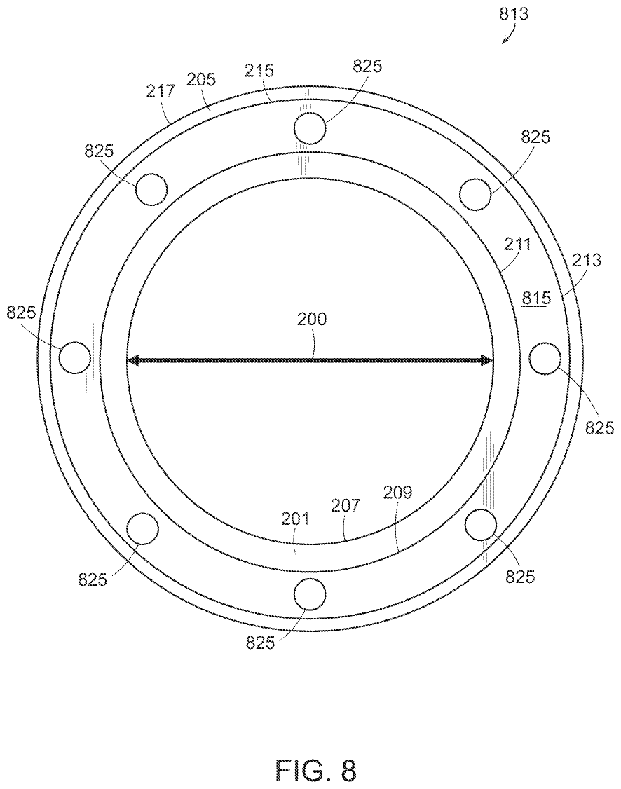

In the previously depicted embodiments, each of the strata of a corresponding radial damper comprises a set of a strata that are consistent in dimension and arrangement throughout the annular structure of the radial damper. However, alternative arrangements may be utilized without deviating from the teachings disclosed herein. FIG. 8 comprises depicts one such configuration of a radial damper 813 that is comparable in arrangement and configuration to radial damper 113 (see FIG. 2). In the depicted embodiment, radial damper 813 comprises the same dimensioning and identical configurations of first stratum 201 and third stratum 205 as exhibited in radial damper 113. However, radial damper 813 comprises a second stratum 815 that is distinct from the second stratum 203 of radial damper 113. Second stratum 815 is comprised of the same outer dimensions and cross-sectional characteristics as second stratum 203, but also exhibits a number of a vacancies 815 within the material. Vacancies 815 may advantageously provide space for the bulk of the polymer within second stratum 815 to experience deformation when dampening radial or axial forces, thus improving the dampening effect exhibited by radial damper 813. Additionally, the vacancies may permit efficient manufacture of the stratum, such as using a specialized extrusion process. In an additional advantage, mass manufacture of radial damper 813 may be more cost-effective, as the vacancies require a smaller bulk quantity of material for each iterative manufacture of second stratum 813.

The vacancies 815 may exhibit radial symmetry within the second stratum 813 of an arbitrary n^{th} order. In the depicted embodiment, the vacancies exhibit radial symmetry of the 8^{th} order, but other embodiments may comprise other configurations without deviating from the teachings disclosed herein. In the depicted embodiment, each of the vacancies comprises a circular vacancy, but other embodiments may comprise other shapes or different shapes within the same embodiment without deviating from the teachings disclosed herein. In the depicted embodiment, each of the first stratum 201 and third stratum 205 comprise continuous and regular arrangement of materials, but other embodiments may comprise other configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A radial damper configured to be positioned about a rack bar within a bushing sleeve of an automotive steering rack in an automobile, the radial damper comprising:
a first stratum having a first rack surface, a first sleeve surface disposed parallel to the first rack surface, and a first interface surface, wherein the first rack surface is closer to the rack bar than the first sleeve surface and the first sleeve surface is closer to the bushing sleeve than the first rack surface when the radial damper is positioned about the rack bar; and
a second stratum disposed between the first stratum and the bushing sleeve,
wherein the radial damper dampens a radial force exerted upon the rack bar by the bushing sleeve during motion of the automobile, wherein the second stratum extends from the first interface surface, wherein the first rack surface has greater axial dimension than the first sleeve surface, and wherein second stratum has a greater resilience to radial forces than the first stratum.

2. The radial damper of claim 1, wherein second stratum has a greater resilience to radial forces than the first stratum.

3. The radial damper of claim 1, wherein the first rack surface and the first sleeve surface form a right angle with the first coupling surface.

4. The radial damper of claim 1, wherein the first stratum comprises a metal and the second stratum a polymer.

5. The radial damper of claim 4, wherein the second stratum comprises an elastomer.

6. A radial damper configured to be positioned about a rack bar within a bushing sleeve of an automotive steering rack in an automobile, the radial damper comprising:
a first stratum having a first portion that abuts the rack bar and a second portion that abuts the bushing sleeve; and
a second stratum that is disposed between the first portion and the bushing sleeve,
wherein the first portion and the second portion form an angle.

7. The radial damper of claim 6, wherein the angle comprises a right angle.

8. The radial damper of claim 6, wherein the second stratum comprises a third portion and a fourth portion, wherein the third portion and the fourth portion form a second angle.

9. The radial damper of claim 8, wherein the second angle comprises a right angle.
